(19) United States
(12) Patent Application Publication
(10) Pub. No.: US 2019/0084106 A1
(43) Pub. Date: Mar. 21, 2019

(54) SYSTEM FOR CHANGING AND INSERTING OR PLACING TOOLS ON A MACHINE TOOL AND MACHINE TOOL WITH SUCH A SYSTEM

(71) Applicant: DECKEL MAHO PFRONTEN GMBH, Pfronten (DE)

(72) Inventors: Rolf KETTEMER, Marktoberdorf (DE); Daniel BELONI, Wildpoldsried (DE)

(73) Assignee: DECKEL MAHO PFRONTEN GMBH, Pfronten (DE)

(21) Appl. No.: 16/134,182

(22) Filed: Sep. 18, 2018

(30) Foreign Application Priority Data
Sep. 18, 2017 (DE) 10 2017 216 447.6

(51) Int. Cl. B23Q 3/157

(52) U.S. Cl. CPC B23Q 3/15713

(57) ABSTRACT

A system for changing and inserting or placing tools on a machine tool, including: a tool changer with a manipulator which is configured to remove a tool to be introduced from a tool magazine of the machine tool at a removal position and to transfer it to a work spindle of the machine tool at a tool change position in an automatic tool changing operation, and a tool diameter measuring apparatus, which is configured to determine a tool diameter or a tool radius of the tool to be introduced that has been removed from the tool magazine of the machine tool by the manipulator.

The present invention relates to a system for changing and inserting or placing tools on a machine tool and to a machine tool with such a system.

### BACKGROUND

WO 2013/030373 A1 discloses a system for changing and inserting or placing tools on a machine tool and a machine tool with such a system. This system is a system comprising a tool magazine for receiving a plurality of tools for use on a machine tool, in particular a numerically controlled machine tool.

The machine tool comprises, for example, several linear and/or swivel or rotary axes for controlling a relative movement of a tool held on the work spindle of the machine tool relative to a workpiece clamped on the machine tool.

Up to now it was known to provide other machine tools for milling/drilling, e.g. milling machines, milling machines/lathes, universal machine tools and machining centers, than for grinding operations, for which special machines or grinding machines were previously intended especially for grinding operations.

However, it is now provided that the machine tools set up for milling operations will also be set up for grinding operations, so that machine tools with tool changers are provided which can use both milling tools and grinding tools on the machine tool, so that milling and grinding operations can be carried out on the same machine tool and in particular without intermediate downtimes. For this purpose, DE 20 201 7 000 560 U1, for example, proposes a tool holder that can hold a grinding wheel for grinding on a conventional tool interface that can be accommodated in a tool magazine or a tool-carrying work spindle, such as an HSK interface (hollow shank taper interface). This means that tool magazines can now be equipped with milling tools, drilling tools and grinding tools on a universal machine tool with tool changer, and milling tools, drilling tools and grinding tools can be used on the work spindle of the machine tool via the tool changer.

The underlying object here is to provide a system for changing and inserting or placing tools on a machine tool and a machine tool with such a system that makes it possible to use milling and drilling tools as well as grinding tools on the machine tool in an efficient way, without downtimes and with the necessary safety.

### SUMMARY

In order to achieve the above object, a system for changing and inserting or placing tools on a machine tool according to claim 1 and a machine tool with such a system is proposed. Dependent claims relate to preferred embodiments of the invention.

According to one aspect, a system for changing and inserting or placing tools on a machine tool is proposed, comprising a tool changing apparatus with a manipulator which is configured to remove a tool to be introduced from a tool magazine of the machine tool at a removal position and to transfer it to a work spindle of the machine tool at a tool changing position in an automatic tool changing operation, and a tool diameter measuring apparatus which is configured to determine a tool diameter or tool radius of the tool to be introduced that has been removed from the tool magazine of the machine tool by the manipulator.

In a practical embodiment, the manipulator is configured to move between the removal position of the tool magazine of the machine tool and the tool change position.

In a practical embodiment, the tool diameter measuring apparatus is configured to determine the tool diameter or tool radius of the tool to be introduced that has been removed from the tool magazine of the machine tool by the manipulator, at a measuring position arranged between the removal position and the tool change position.

In a practical embodiment, the manipulator has a tool gripper for gripping the tool to be introduced.

In a practical embodiment, the tool diameter measuring apparatus is configured to determine the tool diameter or tool radius of the tool held by the manipulator on the tool gripper.

In a practical embodiment, the tool diameter measuring apparatus has an optical measuring device for the optical measurement of the tool to be introduced, in particular comprising a camera and/or a light grid.

In a practical embodiment, the tool diameter measuring apparatus has a light grid receiver and a light grid transmitter.

In a practical embodiment, the light grid receiver or the light grid transmitter is arranged on the manipulator of the tool changer.

In a practical embodiment, the light grid transmitter and/or the light grid receiver is/are arranged on a rack holding the tool magazine.

In a practical embodiment, the light grid transmitter and/or the light grid receiver is/are arranged in a respective transparent housing, in particular made of a plastic material or glass.

In a practical embodiment, the system comprises a position sensor configured to detect when the manipulator is at a measuring position and the tool diameter measuring apparatus is preferably configured to determine the tool diameter or tool radius of the tool to be introduced that has been removed from the tool magazine of the machine tool by the manipulator when the position sensor detects that the manipulator is at the measuring position.

In an appropriate embodiment, the system comprises a safety device which is configured to determine a maximum permissible spindle speed of the work spindle for the tool to be introduced on the basis of a tool diameter or tool radius determined by the tool diameter measuring apparatus.

In an appropriate embodiment, the safety apparatus is configured to determine the maximum permissible spindle speed of the work spindle for the tool to be introduced on the basis of the tool diameter or tool radius determined by the tool diameter measuring apparatus and of the tool type.

In a practical embodiment, the safety apparatus is configured to monitor the spindle speed of the work spindle when machining a workpiece with the tool to be introduced and to perform a processing stop and/or issue a warning to an operator if the monitored spindle speed exceeds the set maximum permissible spindle speed of the work spindle for the tool to be introduced.

In a practical embodiment, the safety apparatus is configured to compare the tool diameter or tool radius of the tool to be introduced, which is determined by the tool diameter measuring apparatus, with a nominal diameter or nominal radius and/or a nominal diameter range or nominal radius range, and to carry out a processing stop and/or issue a warning to an operator if the tool diameter or tool radius of the tool to be introduced, which is determined by the tool diameter measuring apparatus, deviates from the nominal diameter or nominal radius and/or the nominal diameter range or nominal radius range.

According to another aspect, a machine tool is proposed, which has a tool carrying work spindle, a tool magazine, and a system according to any of the above aspects.

In a practical embodiment, a control apparatus of the machine tool is connected to the tool diameter measuring apparatus and is configured to set a maximum permissible spindle speed of the work spindle for the tool to be introduced on the basis of a tool diameter or tool radius determined by the tool diameter measuring apparatus.

In an appropriate embodiment, the control apparatus of the machine tool is configured to set a maximum permissible spindle speed of the work spindle for the tool to be introduced on the basis of the tool diameter or tool radius determined by the tool diameter measuring apparatus and of the tool type.

In an appropriate embodiment, the control apparatus of the machine tool is configured to monitor the spindle speed of the work spindle while machining a workpiece with the tool to be introduced and to perform a processing stop and/or issue a warning to an operator if the monitored spindle speed exceeds the set maximum permissible spindle speed of the work spindle for the tool to be introduced.

In an appropriate embodiment, the control apparatus is configured to compare the tool diameter or tool radius of the tool to be introduced, which is determined by the tool diameter measuring apparatus, with a nominal diameter or nominal radius and/or a nominal diameter range or nominal radius range, and to carry out a processing stop and/or issue a warning to an operator if the tool diameter or tool radius of the tool to be introduced, which is determined by the tool diameter measuring apparatus, deviates from the nominal diameter or nominal radius and/or the nominal diameter range or nominal radius range.

### BRIEF DESCRIPTION OF THE DRAWINGS

FIG. 1 shows schematically a perspective view of a system for changing and inserting or placing tools on a machine tool according to an exemplary embodiment on a machine tool;

FIG. 2 shows schematically a detailed view of a system for changing and inserting or placing tools on a machine tool according to an exemplary embodiment on a machine tool;

FIG. 3 shows schematically a front view of a system for changing and inserting or placing tools on a machine tool according to an exemplary embodiment on a machine tool;

FIGS. 4A, 4B and 4C illustrate schematically a diameter measurement of a tool on a system for changing and inserting or placing tools on a machine tool according to an exemplary embodiment on a machine tool; and

FIG. 5 shows an exemplary flow diagram of a tool change according to an embodiment.

### DETAILED DESCRIPTION OF THE DRAWINGS AND PREFERRED EMBODIMENTS OF THE PRESENT INVENTION

In the following, examples and embodiments of the present invention are described in detail with reference to the attached drawings. Identical or similar elements in the drawings can be designated with identical reference signs. It should be noted, however, that the present invention is in no way limited or restricted to the below described embodiments and the features thereof, but also includes modifications of the embodiments, in particular those which are covered by modifications of the features of the described examples or by combining one or more of the features of the described examples within the scope of protection of the independent claims.

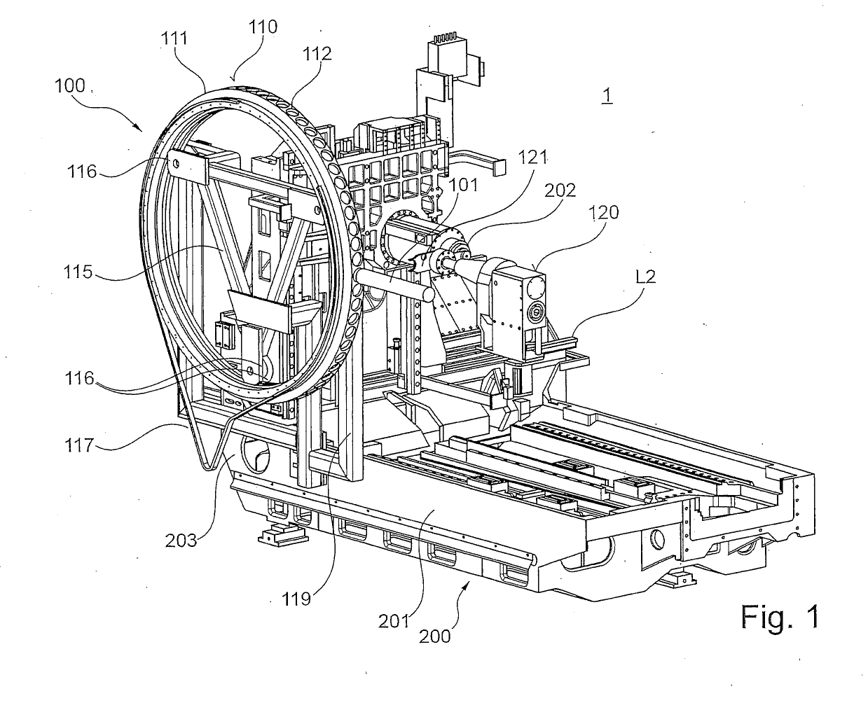

FIG. 1 shows, by way of example, a system 1 for changing and inserting or placing tools in a machine tool 200, in which the tool magazine 110 is designed e.g. as a wheel magazine.

The machine tool 200 is equipped, for example, with a tool-supporting work spindle 202. In addition, the machine tool 200 has a machine bed 201, on which a workpiece clamping table can be arranged. Furthermore, the machine tool 200 can have one or more linear axes, preferably three linear axes (X, Y and Z axes), each for driving a translatory relative movement of a tool clamped on the workpiece clamping table relative to a tool clamped on the work spindle 202. In addition, the machine tool 200 can have one or more round or swivel axes, preferably two or three round and/or swivel axes, each for driving a rotary relative movement of the tool clamped on the workpiece clamping table relative to the tool clamped on the work spindle 202.

System 1 comprises a tool magazine 100, which in the embodiment shown here has an annular wheel magazine 110, in which a plurality of tools 101 can each be stored for tool storage.

The tools 101 are held at an end point 102 along the circumference 111 of the wheel magazine 110. The wheel magazine is designed as an annular hollow cylinder. Along the circumference 111 of the wheel magazine 110, i.e. along the outer lateral surface there are tool holders 112, which can form a detachable connection to the tools 101.

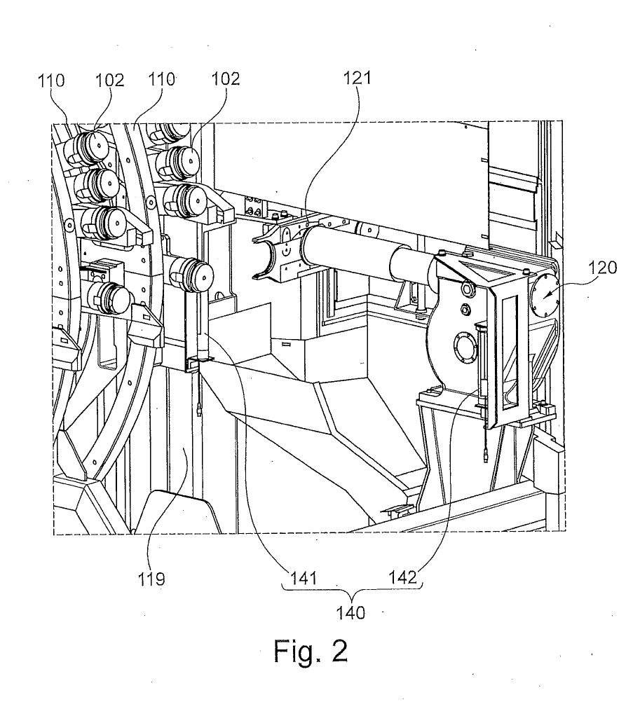

In FIG. 1, the tool holders 112 are arranged as a hole structure along the outer lateral surface of the wheel magazine, which allows a particularly light design. The tools are locked in the holders 112 due to the centrifugal and gravitational forces. In the present example, an active locking system is implemented by means of a snap-in connection with the tools, in which the tools are positively locked in a form-fitting connection. For example, a self-retaining hollow shank taper with face contact (HSK) is used as tool interface 102 for fastening the tools 101 in the tool holders 112 (see FIG. 2). Alternatively, a steep taper or morse taper can be used.

The tools are thus only attached via one of their longitudinal ends to the outer circumference of the wheel magazine 110, so that in a radial direction the tools protrude radially outwards from the outer circumference of the wheel magazine. This means that the longitudinal axes of the tools are in one plane. This allows an extremely compact and close arrangement of the tools side by side along the circumference 111 of the wheel magazine 110.

The wheel magazine 110 can be equipped with all common tools for non-cutting and cutting production. To illustrate the design principle, FIG. 1 only shows an equipment with one tool 101. In addition, the wheel magazine 110 can be equipped with e.g. milling tools, on the one hand, and grinding tools, on the other hand (e.g. grinding wheels).

The wheel magazine is exemplarily mounted by means of a triangular frame 115, each of the three end points of which is equipped with an impeller 116. In addition to the three-point bearing shown here, a four- or multipoint bearing is also possible. Instead of the triangular frame 115, the wheel magazine can also be supported by a central axis. The rotation of the wheel magazine 110 is carried out via a chain drive, wherein only the drive chain 117 is shown in FIG. 1. Instead of the chain drive shown here, the wheel magazine 110 can also be driven directly via a sprocket or via a frictional connection.

System 1 also includes an e.g. horizontally movable manipulator 120 for removing the tools 101 from the tool magazine 100, so that they can be fed to the tool spindle 202 of the machine tool 200. For this purpose, the manipulator 120 can be moved e.g. horizontally between the work spindle 202 and the wheel magazine 110. The manipulator 120 has, for example, a double gripper 121, with two gripper sections for gripping a tool interface 102 of a tool 101 (e.g. on a gripper groove).

The machine tool 200 can be a machine tool which is known from the prior art and used for the cutting or non-cutting production. The system 1 is particularly advantageous for changing and inserting or placing tools for universal machining centers as they must be flexibly equipped with many different tools. The most compact arrangement possible is achieved when the tool magazine 100 is attached to the side of the bed 201 and the frame 203 in an upright position to allow short feed paths of the manipulator 120 to the spindle 202. Due to the possibility of an upright positioning of the wheel magazines 110, the tool changing system can almost always be positioned as close to the spindle as possible, even with different frames and bed shapes.

The manipulator 120 from the tool magazine 100 is arranged outside with respect to the unloaded wheel magazine 110, i.e. outside the circumference of the wheel magazine 110, so that it can remove the tools 101 in the direction of the rotary axis of the wheel magazine and/or in the radial direction from the wheel magazine 110 outwards. The manipulator shown here schematically comprises a first linear axis which is suitable for moving the manipulator in the direction of the rotary axis of the wheel magazine, i.e. in the lateral direction to the wheel magazine in order to execute a horizontal movement between the spindle 202 and the wheel magazine 110. The manipulator 120 can also have a second linear axis which is suitable for moving the manipulator in a radial direction in the changing position on the wheel magazine.

The manipulator 120 is designed as a swivel-blade exchanger with double gripper 121 for removing the tools 101 in the illustrated embodiment, with a left-sided and a right-sided holder. The double gripper 121 allows the last tool used and the tool required afterwards to be picked up simultaneously, so that tools can be exchanged between spindle 202 and tool magazine 110 with only one horizontal movement of the manipulator 120. The tool magazine 100 can optionally be equipped with one or more wheel magazines 110.

FIG. 2 shows schematically a detailed view of a system for changing and inserting or placing tools on a machine tool according to an exemplary embodiment on a machine tool.

FIG. 2 shows, by way of example, two wheel magazines 110 arranged in parallel, with tool interfaces 102 (by way of example without tools) held at their peripheral tool positions, and the manipulator 120 with the exemplary double gripper 121 (tool gripper).

As an example, a light grid receiver 141 of a tool diameter measuring apparatus 140, which is arranged between the work spindle 202 and the wheel magazine(s) 110, is arranged on the frame 119 holding the wheel magazines 110. At the same height as the light grid receiver 142, a light grid transmitter 142 of the tool diameter measuring apparatus 140 is arranged on the horizontally movable manipulator 120.

In this embodiment, the light grid receiver 141 is arranged, by way of example, stationary on the frame 119 holding the wheel magazines 110 and the light grid transmitter 142 of the tool diameter measuring apparatus 140 is arranged, for example, on the movable manipulator 120, but in other embodiments the light grid transmitter 142 of the tool diameter measuring apparatus 140 can also be arranged stationary on the frame 119 holding the wheel magazines 110 and the light grid receiver 141 can be arranged on the movable manipulator 120. In further embodiments, light grid receiver 141 and light grid transmitter 142 can also be arranged stationary opposite one another in such a way that the manipulator 120 with the tool gripper 121 can be moved between the light grid receiver 141 and the light grid transmitter 142.

The light grid transmitter 142 can emit visible or invisible light (e.g. in the infrared range), and the light grid receiver 141 is configured to detect the light of the light grid transmitter 142.

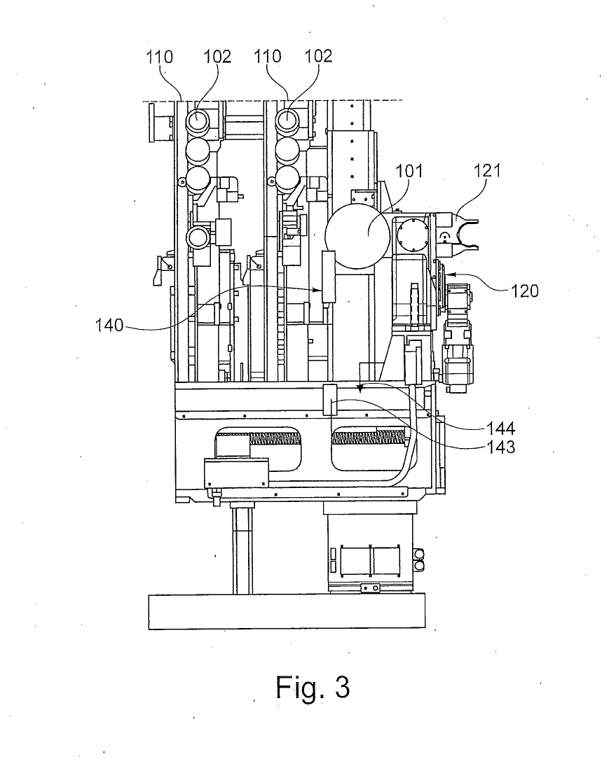

FIG. 3 shows schematically a front view of a system for changing and inserting or placing tools on a machine tool according to an exemplary embodiment on a machine tool.

In FIG. 3, e.g. a grinding wheel as tool 101 is held on the tool gripper 121 of the manipulator 120. It can be seen, for example, that the area covered, in a view from above, by the light grid receiver 141 and the light grid transmitter 142 of the tool diameter measuring apparatus 140 is traversed when the manipulator 120 is moved horizontally from the tool magazines 110 to the right towards the work spindle 202 of the machine tool 202 e.g. by a lower section of the tool 101 and/or the grinding wheel.

Here it is intended that a measurement of the tool diameter measuring apparatus 140 takes place at a given position, especially if the moving part (i.e. in FIG. 2 e.g. the light grid transmitter 142) is directly opposite the stationary part (i.e. in FIG. 2 e.g. the light grid receiver 141).

The measuring position is determined, for example, by a position sensor 143, which can be designed e.g. as an induction sensor, and can be detected via a movable sensor part 144, which is arranged on the manipulator 120 and is moved with the manipulator 120 if the manipulator 120 is positioned at the measuring position.

The diameter measurement of tool 110 can here be carried out at the measuring position with traversing manipulator 120, exactly at a time when it is detected via the movable sensor part 144 and the position sensor 143 that the manipulator is positioned at the measuring position, or the manipulator 120 can be stopped when it is detected via the movable sensor part 144 and the position sensor 143 that the manipulator is positioned at the measuring position to carry out the diameter measurement of tool 110 at the measuring position with manipulator 120 stopped.

In both cases, the diameter measurement of tool 110 can be carried out while a tool 101 is being introduced at the work spindle 202, so that additional down times on the machine tool can be advantageously avoided, as would be the case if the diameter measurement were carried out at a designated point in the working area or on the work spindle, for example. In addition, it is advantageously possible to avoid additional sensors or cameras in the working area of the machine tool 200.

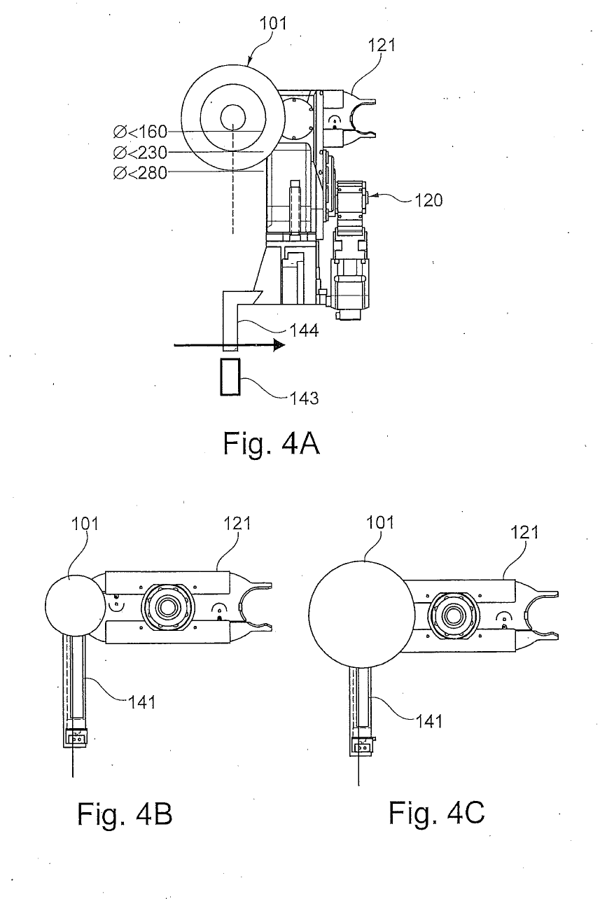

FIGS. 4A, 4B and 4C illustrate schematically a diameter measurement of a tool on a system for changing and inserting or placing tools on a machine tool according to an exemplary embodiment on a machine tool.

For example, the manipulator 120 is positioned in the measuring position in FIG. 4A and thus the movable sensor part 144 is positioned on the position sensor 143 and the position sensor 143 detects that the manipulator 120 is positioned at the measuring position.

In the measuring position, the tool 101 taken from the tool magazine 110 is held on the gripper section of the tool gripper 121 in such a way that the tool 101 (grinding wheels of different diameters are shown as examples) is positioned on the measuring surface between the light grid receiver 141 and the light grid transmitter 142 of the tool diameter measuring apparatus 140.

Therefore, the tool diameter measuring apparatus 140 can be activated at this measuring position and the diameter of the tool 101 can be measured, e.g. by determining the degree of overlap of the tool 101 with the measuring surface between the light grid receiver 141 and the light grid transmitter 142 of the tool diameter measuring apparatus 140.

FIG. 4B shows here, for example, a lower degree of overlap of the tool 101 with the measuring surface between the light grid receiver 141 and the light grid transmitter 142 of the tool diameter measuring apparatus 140 due to a smaller tool diameter of a smaller grinding wheel, and FIG. 4C shows here, for example, a larger degree of overlap of the tool 101 with the measuring surface between the light grid receiver 141 and the light grid transmitter 142 of the tool diameter measuring apparatus 140 due to a larger tool diameter of a larger grinding wheel.

In some embodiments of the invention, light grid receiver 141 and/or light grid transmitter 142 of the tool diameter measuring apparatus 140 can be arranged in a respective transparent housing (e.g. made of a plastic material or glass), with the advantage that these are then protected against splash water (e.g. cooling liquid).

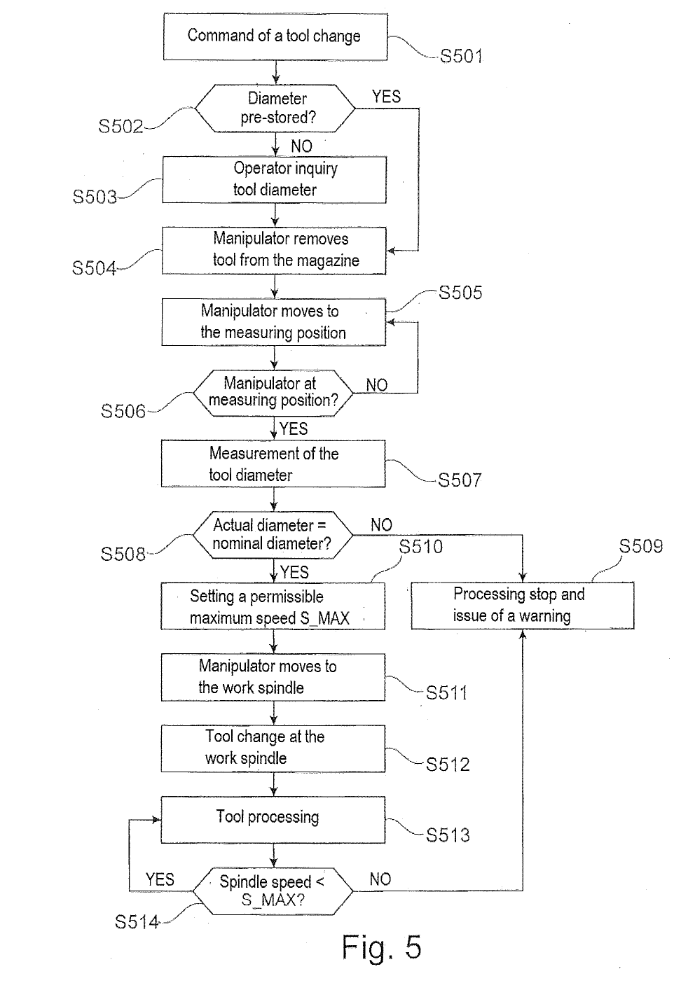

FIG. 5 shows an exemplary flow diagram of a tool change according to one embodiment.

A tool change is instructed in step S501. This can be done on the basis of a running NC program or an NC program executed by the machine control, or on the basis of an operator command on the control panel or on the machine control of the machine tool.

In a step S502 it is checked whether a tool type and/or a tool diameter has been pre-stored for the tool to be removed. If this is not the case, the operator may be asked in step S503 to enter a diameter and/or tool type at the control panel or machine control of the machine tool (operator inquiry tool diameter). This is particularly advantageous for grinding tools and grinding wheels.

In step S504, the manipulator 120 moves to the tool magazine that holds the tool to be removed and removes the tool to be introduced. This tool can be a milling or drilling tool, or it can also be a grinding tool, such as a grinding wheel. Having removed the tool from the magazine, the manipulator 120 moves with the tool held in the tool gripper 121 of the manipulator 120 in the direction of the work spindle 202 to the measuring position between the tool magazine and the work spindle; step S505.

This has the advantage that the tool diameter can be measured at the measuring position between tool magazine and work spindle during the tool change process, so that additional down times can be avoided. The tool diameter is advantageously measured in the already scheduled non-productive time of the tool change.

As soon as the manipulator 120 arrives at the measuring position, which is detected by the position sensor 143 (step S506 gives YES), the measuring apparatus 140 is activated. The manipulator 120 can either stop briefly or pass through the measuring point while the measuring apparatus 140 is activated.

In step S507, the tool diameter of the tool 101 to be introduced is measured or determined at the measuring position by means of the tool diameter measuring apparatus 140, in particular e.g. by means of the light grid receiver 141 and the light grid transmitter 142 of the tool diameter measuring apparatus 140; see in particular FIGS. 4A to 4C.

In step S508, it is determined whether the measured or determined tool diameter (actual diameter) corresponds to the predetermined, preset, pre-stored or operator-entered diameter (nominal diameter). Alternatively, it can be determined whether the measured or determined tool diameter (actual diameter) falls within a predetermined, preset, pre-stored or operator-entered permissible diameter range.

If the check in step S508 is negative, machining can be stopped at the machine tool and/or a warning can be issued to the operator in a step S509.

If the check in step S508 is positive and the measured or determined tool diameter corresponds to the predetermined, preset, pre-stored or operator-entered diameter or diameter range, machining with the workpiece can be enabled.

For this purpose, it is preferred, especially with grinding tools, that a permissible maximum speed S_MAX is set in step S510 based on the tool diameter measured or determined in step S507.

Here, permissible maximum speeds can be pre-stored in the machine control on the basis of tool diameters and/or tool diameter ranges, with larger tool diameters being preferably assigned to smaller permissible maximum speeds and smaller tool diameters being preferably assigned to larger permissible maximum speeds.

In addition, permissible maximum speeds can be set on the basis of a tool type, so that e.g. grinding tools are assigned to lower permissible maximum speeds than tools with a certain cutting edge, e.g. milling or drilling tools.

This has the advantage that the diameter of the tool can be checked directly during the tool change process and, depending on the diameter and tool type, a suitable maximum permissible speed can be set which corresponds to the safety regulations suitable for the specific tool type. This makes it advantageously possible to equip the same machine tool with milling and drilling tools as well as grinding tools without compromising safety.

In step S511, the manipulator 120 then moves to the work spindle 202 and performs the tool change at the work spindle 202 in step S512, wherein the tool 101 measured in step S507 is introduced at the work spindle 202 (and, if necessary, a tool previously picked up there is removed in order to be returned to the tool magazine).

After introducing the tool 101 on work spindle 202, the workpiece can be processed with the introduced tool in step S513. In this connection, it is always checked in a step S514 whether the spindle speed remains below the maximum permissible speed S_MAX set in step S510.

If the spindle speed exceeds the maximum permissible speed S_MAX, the processing operation is stopped in step S509 and a warning is issued to the operator.

This ensures in an advantageous way that the spindle speed does not exceed the maximum permissible speed for the respective tool diameter, in particular in the case of grinding tools or grinding wheels.

In order to further increase safety, steps S508 and/or S514, each of which can lead to a processing stop and/or a warning to the operator, can be checked by two devices working redundantly side by side. For example, it is advantageously possible that the control apparatus or in particular the PLC (Program Logic Control; or SPS speicherprogrammierbare Steuerung) of the machine tool 200, carries out steps S508 and/or S514 and also a second, independent safety apparatus carries out steps S508 and/or S514.

In the above embodiments, a tool diameter measuring apparatus with a light grid transmitter and a light grid receiver was proposed. However, the present invention is not limited to tool diameter measuring apparatuses using light grid transmitters and light grid receivers. Further optically working tool diameter measuring apparatuses can be proposed, e.g. with one or more light barriers or also with one or more cameras for the analysis of the tool diameter by optical measurement.

In summary, a system for changing and inserting or placing tools on a machine tool and a machine tool with such a system can be proposed which makes it possible to use milling and drilling tools as well as grinding tools on the machine tool efficiently, without down times and with the necessary safety.

1. A system for changing and inserting or placing tools on a machine tool, comprising:
a tool changer with a manipulator which is configured to remove a tool to be introduced from a tool magazine of the machine tool at a removal position and to transfer it to a work spindle of the machine tool at a tool changing position in an automatic tool changing process, and
a tool diameter measuring apparatus configured to determine a tool diameter or tool radius of the tool to be introduced that has been removed from the tool magazine of the machine tool by the manipulator.

2. The system according to claim 1, wherein
the manipulator is configured to move between the removal position of the tool magazine of
the machine tool and the tool change position, and
the tool diameter measuring apparatus is configured to determine the tool diameter or tool radius of the tool to be introduced that has been removed from the tool magazine of the machine tool by the manipulator at a measuring position arranged between the removal position and the tool change position.

3. The system according to claim 1, wherein characterized in that
the manipulator has a tool gripper for gripping the tool to be introduced, and
the tool diameter measuring apparatus is configured to determine the tool diameter or tool radius of the tool held by the manipulator on the tool gripper.

4. The system according to claim 1, wherein
the tool diameter measuring apparatus has an optical measuring device for optically measuring the tool to be introduced, in particular comprising a camera and/or a light grid.

5. The system according to claim 1, wherein
the tool diameter measuring apparatus has a light grid receiver and a light grid transmitter.

6. The system according to claim 5, wherein
the light grid receiver or the light grid transmitter is arranged on the manipulator of the tool changer.

7. The system according to claim 5, wherein
the light grid transmitter and/or the light grid receiver are/is arranged on a rack holding the tool magazine.

8. The system according to claim 5, wherein
the light grid transmitter and/or the light grid receiver is/are arranged in a respective transparent housing, in particular made of a plastic material or glass.

9. The system according to claim 1, wherein
a position sensor configured to detect when the manipulator is at a measuring position, and
the tool diameter measuring apparatus is configured to determine the tool diameter or tool radius of the tool to be introduced that has been removed from the tool magazine of the machine tool by the manipulator, when the position sensor detects that the manipulator is at the measuring position.

10. The system according to claim 1, wherein
a safety apparatus configured to determine a maximum permissible spindle speed of the work spindle for the tool to be introduced on the basis of a tool diameter or tool radius determined by the tool diameter measuring apparatus.

11. The system according to claim 10, wherein
the safety apparatus is configured to determine a maximum permissible spindle speed of the work spindle for the tool to be introduced on the basis of the tool diameter or tool radius determined by the tool diameter measuring apparatus and of the tool type.

12. The system according to claim 10, wherein
the safety apparatus is configured to monitor the spindle speed of the work spindle while processing a workpiece with the tool to be introduced and to perform a processing stop and/or issue a warning to an operator if the monitored spindle speed exceeds the set maximum allowable spindle speed of the work spindle for the tool to be introduced.

13. The system according to claim 10, wherein
the safety apparatus is configured to compare the tool diameter or tool radius of the tool to be introduced, which is determined by the tool diameter measuring apparatus, with a nominal diameter or nominal radius and/or a nominal diameter range or nominal radius range, and to carry out a processing stop and/or issue a warning to an operator if the tool diameter or tool radius of the tool to be introduced, which is determined by the tool diameter measuring apparatus, deviates from the nominal diameter or nominal radius and/or the nominal diameter range or nominal radius range.

14. A machine tool comprising:
a tool-carrying work spindle,
a tool magazine, and
a system according to claim 1.

15. The machine tool according to claim 14, wherein
a control apparatus of the machine tool is connected to the tool diameter measuring apparatus and is configured to set a maximum permissible spindle speed of the work spindle for the tool to be introduced, on the basis of a tool diameter or tool radius determined by the tool diameter measuring apparatus.

16. The machine tool according to claim 15, wherein
the control apparatus of the machine tool is configured to set a maximum permissible spindle speed of the work spindle for the tool to be introduced on the basis of the tool diameter or tool radius determined by the tool diameter measuring apparatus and of the tool type.

17. The machine tool according to claim 15, wherein the control apparatus of the machine tool is configured to monitor the spindle speed of the work spindle while processing a workpiece with the tool to be introduced and to perform a processing stop and/or to issue a warning to an operator if the monitored spindle speed exceeds the set maximum permissible spindle speed of the work spindle for the tool to be introduced.

18. The machine tool according to claim 15, wherein
the control apparatus is configured to compare the tool diameter or tool radius of the tool to be introduced, which is determined by the tool diameter measuring apparatus, with a nominal diameter or nominal radius and/or a nominal diameter range or nominal radius range, and to perform a processing stop and/or issue a warning to an operator if the tool diameter or tool radius of the tool to be introduced, which is determined by the tool diameter measuring apparatus, deviates from the nominal diameter or nominal radius and/or the nominal diameter range or nominal radius range.
